(19) United States
(12) Patent Application Publication
(10) Pub. No.: US 2022/0270061 A1
(43) Pub. Date: Aug. 25, 2022

(54) SYSTEM AND METHOD FOR INDICATING PAYMENT METHOD AVAILABILITY ON A SMART SHOPPING BIN

(71) Applicant: Toshiba TEC Kabushiki Kaisha, Shinagawa-ku (JP)

(72) Inventor: Jia ZHANG, Irvine, CA (US)

(21) Appl. No.: 17/183,843

(22) Filed: Feb. 24, 2021

(51) Int. Cl. G06Q 20/12; G06Q 20/40; G06K 9/00; H04N 7/18

(52) U.S. Cl. CPC G06Q 20/12; G06Q 20/4016; G06K 9/00288; H04N 7/183

(57) ABSTRACT

A system and method for system for indicating payment method availability on a smart shopping bin includes capturing a shopper's facial image as they enter a store and obtain a smart shopping cart. Facial image recognition determines whether that shopper has pre-associated payment information. If so, the shopper and payment information is associated with their cart and a green light is illuminated on the cart. If no payment information is associated with the shopper, a red light is illuminated instead. If the shopper becomes disassociated with their cart while shopping, the light is changed to red. When shopping is complete, shoppers and carts with red lights are set for manual payment, while carts with green lights may use automatic payment on exit.

### TECHNICAL FIELD

This application relates generally to smart shopping bins such as carts or baskets. The application relates more particularly to generating a visible bin indicator as to whether or not a previously stored payment method is available in accordance with a captured shopper biometric.

### BACKGROUND

Traditionally, shopping in a retail premises involves a shopper who places goods in a bin, such as a cart or a basket, as they move about a store. The shopper would take their goods to a checkout counter when shopping was completed. A human clerk would register the purchases through a point-of-sale device and secure payment from the shopper.

More recently retail shops are automated. Some shops only allow customers for whom a valid payment method is established. At some shops a shopper must download an application and register before entry.

### BRIEF DESCRIPTION OF THE DRAWINGS

Various embodiments will become better understood with regard to the following description, appended claims and accompanying drawings wherein:

FIG. 1 an example embodiment of a system for indicating payment method availability on a smart shopping bin;

FIG. 2 is an example embodiment of a digital device system;

FIG. 3 is an example embodiment of a system for indicating payment method availability on a smart shopping bin;

FIG. 4 is an example embodiment of a software block diagram for a system for indicating payment method availability on a smart shopping bin; and

FIG. 5 is an example embodiment of a system for indicating payment method availability on a smart shopping bin.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

Example embodiments herein facilitate allowing customers with or without valid payment to an improved shopping experience at fully or partially automated retail shops. All customers are able to enter shop. If a valid payment method is found for customers, their shopping bin, such as a shopping cart or shopping basket, shows a green light, and that customer can leave with automatic payment. If not, a red light on shopping basket or shopping cart indicates that the customer must pay manually before leaving.

A camera is installed at shop entrance. Another a mobile biosensor, such as camera, and/or other biometric sensor, detects customer biometrics, such as facial characteristics, fingerprint, palm print or retina scan, while they shop. If a valid payment method can be detected in accordance with input from any sensor, a green light installed on a shopping cart or shopping basket will be shown. The payment method is associated with purchases in the shopping bin. Otherwise a red light indicates that customer must either pay at an artificial intelligence based shopping cart or pay at a cashier before leaving.

After a valid payment method is located, sensors on the shopping bin keep verifying that it is not taken by someone else. If a customer becomes disassociated with their bin, the corresponding payment method is disassociated with the bin and a red light replaces the green light.

A customer is provided with way to supply their biometric information, such as their face, finger print, palm print or retina, and associate it with a new or updated payment method. This enables the system to detect the customer the next time and automatically associate their payment method. Stores with multiple locations, such as chain stores, suitably store information in a central database and it is made available to all stores.

In example embodiments herein, a customer is able to determine whether they have a valid payment method based on an indicator light color. A default red color is displayed a customer enters a retail premises. A camera installed at the entrance detects a customer's facial characteristics and tries to locate an associated payment method. If no payment method is found by facial recognition at the entrance, a camera or other biosensor installed on smart shopping cart persistently detects a shopper's biometric information. If no payment method is not found, then a biosensor installed on a bin or basket can locate a customer's payment method through biometric matching. If a valid payment method is found, a bin light turns green indicating that the customer can leave without manual payment. Otherwise, a red light indicates that they must pay manually before leaving.

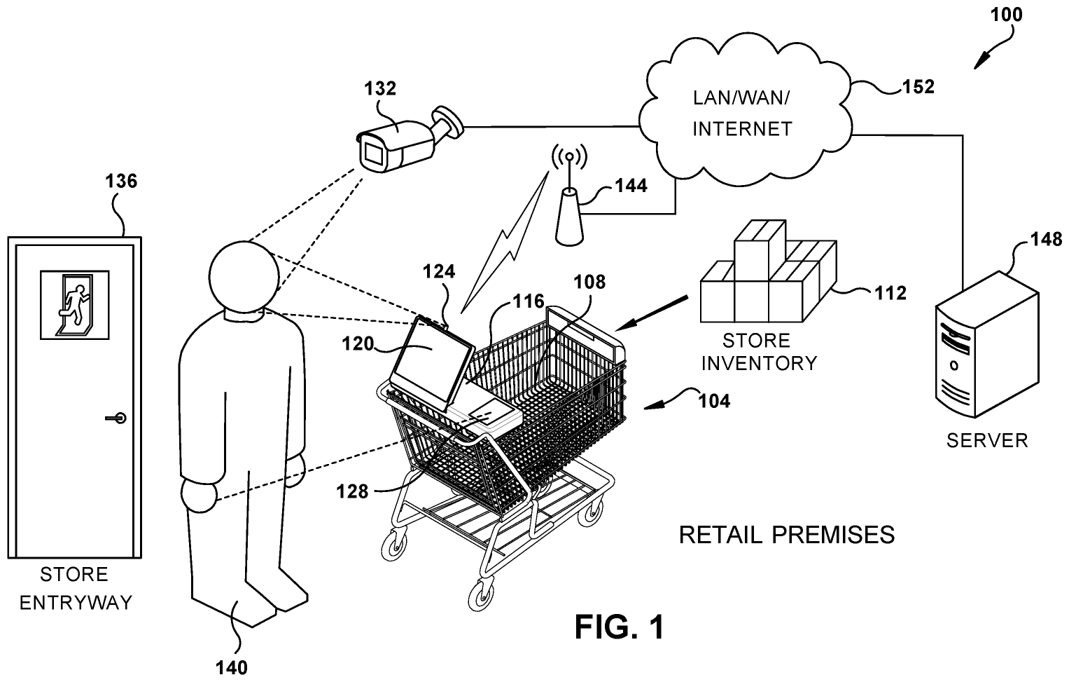

FIG. 1 illustrates an example embodiment of a system 100 for indicating payment method availability on a smart shopping bin, such as shopping cart or basket. In the example, a 104, which can be a smart shopping cart, includes bin 108 configured to receive and transport merchandise selected for purchase, such as merchandise selected from store inventory. Cart 104 also includes an on board computer having a touchscreen user interface 120 and one or more biosensors, such as facial or iris recognition via computer camera 124, or fingerprint or palm print recognition via scanner 128. Cart 104 also includes a wireless data interfaces, such as Bluetooth, Wi-Fi, cellar or the like. In the illustrated example, cart 104 uses embedded Wi-Fi for data communication via hotspot. Camera 132, cart 104 and one or more servers, such as server 148 are in data communication via network cloud 152, suitably comprised of local area network (LAN), a wide area network (WAN) which may comprise the Internet, or any suitable combination thereof. Server 148 is suitably either local or remote from the retail premises. Server 148 receives and stores customer biometric information associatively with one or more of their payment methods, such as bank account, credit card, debit card or prepaid card.

A camera 132 is located near a store entryway 136 and captures biometric images of shopper 140 as they enter a retail premises. Captured images are sent to server 148 for application of facial recognition. If a customer is recognized and if they have an associated payment method, the customer, who takes cart 104, and their payment method is associated with cart 104. If not, the customer may choose to set up a payment method and have it associated with their biometric information, suitably entering the information on touchscreen user interface 120.

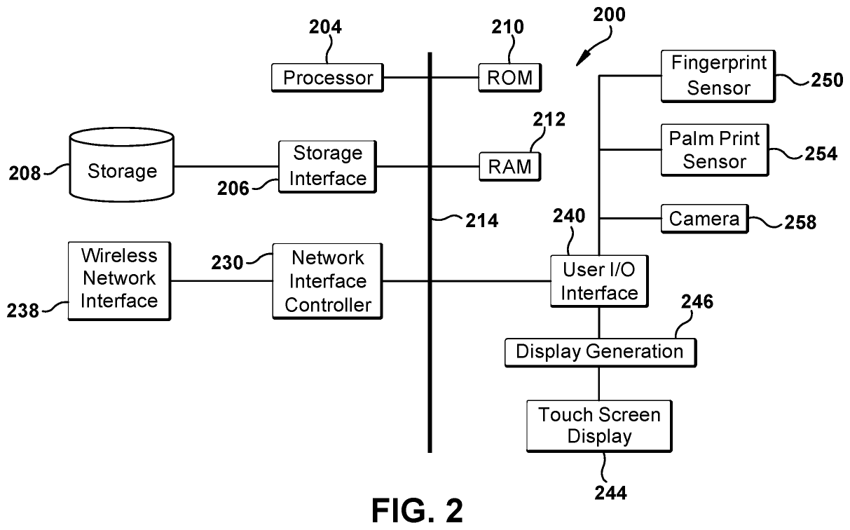

Turning now to FIG. 2, illustrated is an example embodiment of a digital data processing device 200 such as a server on cart 104 of or server 148 of FIG. 1. Components of the digital data processing device 200 suitably include one or more processors, illustrated by processor 204, memory, suitably comprised of read-only memory 210 and random access memory 212, and bulk or other non-volatile storage 208, suitably connected via a storage interface 206. A network interface controller 230 suitably provides a gateway for data communication with other devices, such as via network interface 238. A user input/output interface 240 suitably provides display generation 246 providing a user interface via touchscreen display 244, suitably displaying images from display generator 246. The user input/output interface 240 also suitably provides a data interfaced with fingerprint sensor 250, palm print sensor 254 and digital camera 258. It will be understood that the computational platform to realize the system as detailed further below is suitably implemented on any or all of devices as described above.

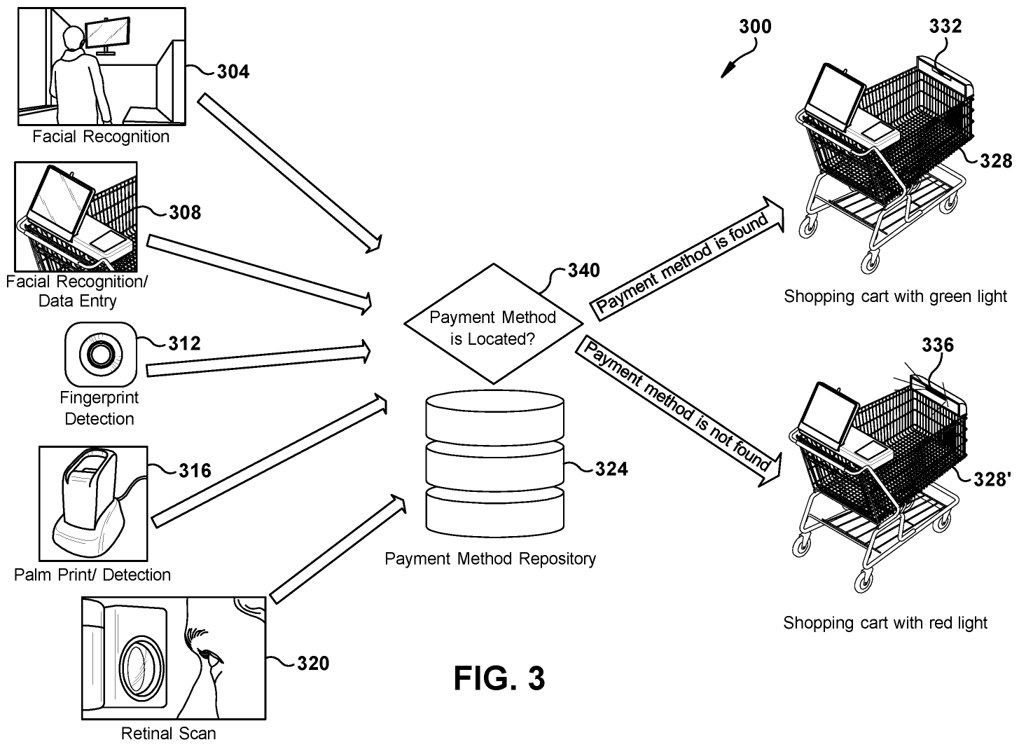

FIG. 3 illustrates an example embodiment of a system 300 for indicating payment method availability on a smart shopping bin. An array of sensors provide biometric and data input, including facial recognition at store entry 304, suitably from a fixed camera. Other sensors are associated with a shopping cart or basket, including facial recognition or data entry via a cart camera and touchscreen at 308, fingerprint detection 312, palm print detection 316 and retinal scan 320. Captured biometric information is stored in and retrieved from payment method repository. A test is made at block 340 to determine if a shopper's captured biometric has or provides a payment method. If so, cart 328 displays green light 332. If not, a red light 336 is displayed as shown on cart 328′.

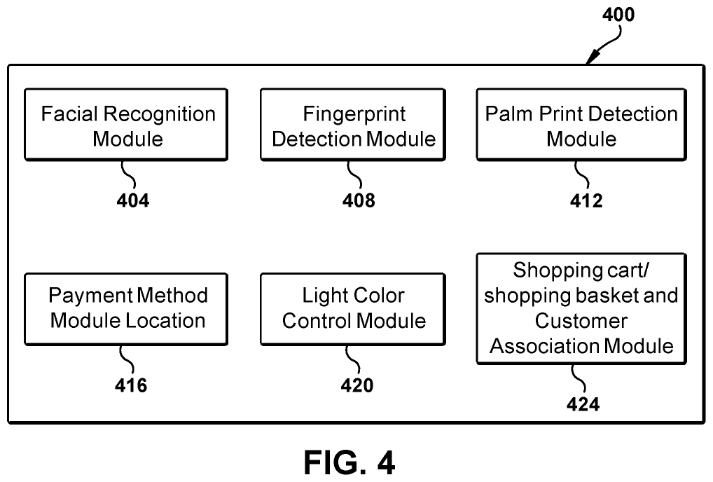

FIG. 4 illustrates an example embodiment of a software block diagram 400 for a system for indicating payment method availability on a smart shopping bin, such as shopping cart or basket. Functional units include facial recognition module 404, fingerprint detection module 408, palm print detection module 412, payment method location module 416, light color control module 420, and shopping cart or shopping basket customer association module 424.

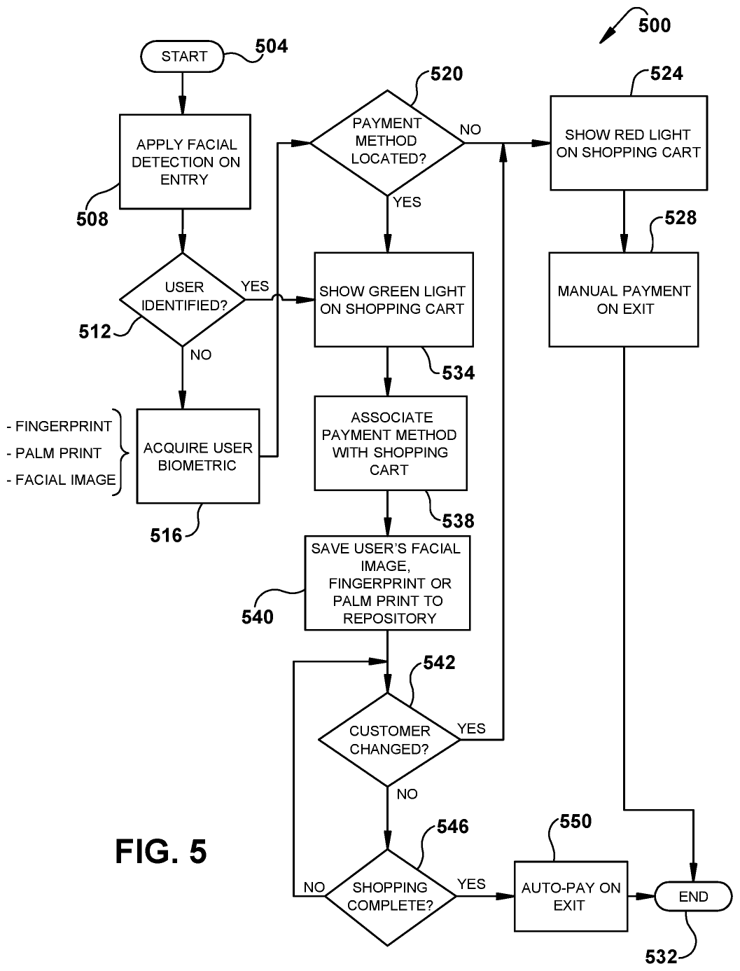

FIG. 5 is a flowchart 500 of an example embodiment of a system for indicating payment method availability on a smart shopping bin, such as shopping cart or basket. The process commences at block 504 and proceeds to block 508 wherein a user's biometric information is captured and facial detection applied as they enter a store. A test is made at block 512 to determine whether the user is identified. If not, captured facial information acquired, suitably complemented by acquiring fingerprint or palm print information, at block 516. Payment information may also be detected or supplied. Next, a test is made at block 520 to determine if a payment is associated with the user. If not, a red light is displayed on a shopping cart at block 524, requiring manual payment at block 528, after which the process ends at block 532.

If a user is identified at block 512, the process proceeds to block 534 where a green light is displayed on the cart. Payment methods are associated with the cart at block 538. Captured biometric information may be stored or updated at block 540. A test is made at block 542 as to whether there was a change in a customer associated with the cart. If so, the process moves to block 524 where the cart light is turned to red, followed by manual payment at block 528 with the process ending at block 532. If the customer is unchanged at block 542, a determination is made at block 546 as to whether shopping is complete. If not, the process returns to block 542. If completed, a green light condition remains and automatic payment is made on exit with the associated payment method is made at block 550 before ending at block 532.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

1. A system comprising:
a biometric sensor system, comprised of one or more biometric sensors, configured to capture biometric data from a human shopper;
a transport bin comprised of a shopping basket or a shopping cart;
memory storing, for each of a plurality of humans, the biometric data associatively with payment method data;
a processor configured to retrieve payment method data associated with the human shopper from the memory in accordance with the captured biometric data;
the processor further configured to generate a first bin light indicator upon successful retrieval of the payment method data;
the processor further configured to generate a second bin light indicator when the payment method data is not retrieved;
the biometric sensor system is further configured for persistent capture of the biometric data;
the processor further configured to generate the second bin light indicator when capture of the human shopper's biometric data is interrupted;
the processor further configured to generate the first bin light indicator when capture of the human shopper's biometric data is reestablished;
the processor further configured to register a price of items in the transport bin; and
the processor further configured to secure payment in accordance with a retrieved payment method when the first bin light indicator is generated after completion of shopping by the human shopper.

2. The system of claim 1 wherein the one or more biometric sensors is comprised of one or more cameras, a fingerprint reader, a retinal scanner or a palm print reader.

3. The system of claim 2 wherein the first bin light indicator is comprised of a light with a first color and the second bin light indicator is comprised of the light with a second color.

4. (canceled)

5. (canceled)

6. The system of claim 3 wherein the biometric sensor system includes:
a stationary camera configured to capture the biometric data from the human shopper's face upon entry to a retail premises, and
one or more mobile biometric sensors associated with the transport bin.

7. The system of claim 1 wherein the processor is further configured to:
receive new payment method data from the human shopper via a user interface,
store the new payment method data associatively with the captured biometric data.

8. A method comprising:
capturing biometric data from a human shopper via a biometric sensor system;
receiving articles into a transport bin comprised of a shopping basket or a shopping cart;
retrieving, from memory, payment method data associated with the human shopper in accordance with captured biometric data,;
generating a first bin light indicator upon successful retrieval of the payment method data;
the generating a second bin indicator when the payment method data is not retrieved;
persistently capturing biometric data vie the biometric sensor system; and
generating the second bin light indicator when capture of the human shoppers biometric data is interrupted;
generating the second bin light indicator when capture of the human shopper's biometric data is interrupted;
generating the first bin light indicator when capture of the human shopper's biometric data is reestablished;
registering a price of items in the transport bin; and
securing payment in accordance with a retrieved payment method when the first bin light indicator is generated after completion of shopping by the human shopper.

9. The method of claim 8 wherein one or more biometric sensors is comprised of one or more cameras, a fingerprint reader, a retinal scanner or a palm print reader.

10. The method of claim 9 wherein the first bin light indicator is comprised of a light with a first color and the second bin light indicator is comprised of the light with a second color.

11. (canceled)

12. (canceled)

13. The method of claim 10 further comprising:
capturing, via a camera biometric data from the human shopper's face upon entry to a retail premises, and
capturing biometric data from one or more mobile biometric sensors associated with the transport bin.

14. The method of claim 8 further comprising:
receiving new payment method data from the human shopper via a user interface, and
storing a new payment method data associatively with the captured biometric data.

15. A method comprising:
capturing, via one or more cameras, a facial image of a human shopper as a human shopper commences shopping at a retail premises;
determining if facial image data captured by the one or more cameras corresponds to previously stored biometric data stored associatively with payment method data;
enabling a first color indicator on a shopping cart when the facial image data corresponds to the payment method data previously stored;
enabling a second color indicator an the shopping cart with the facial image data does not correspond to the payment method data previously stored;
persistently capturing biometric data by the one or wore cameras, and
enabling the second color indicator when capture of the human shopper's biometric data is interrupted;
generating the second color indicator when capture of the human shopper's biometric data is interrupted;
generating the first color indicator when capture of the human shopper's biometric data is reestablished;
registering a price of items in the transport bin; and
securing payment in accordance with a retrieved payment method when the first color indicator is generated after completion of shopping by the human shopper.

16. The method of claim 15 further comprising:
capturing a sequence of images from the one or more cameras or a sequence of biometric sensor readings from the shopping cart; and
disabling the first color indicator and enabling the second color indicator when an image in a sequence or a biometric sensor reading no longer corresponds to the biometric data for the human shopper.

17. The method of claim 15 further comprising:
receiving new payment method data from the human shopper via a user interface; and
storing received new payment method data associatively with the biometric data corresponding to the human shopper.

18. The method of claim 17 comprising automatically securing payment for goods in the shopping cart when the first color indicator is enabled.

19. The method of claim 18 further comprising manually securing payment for the goods when the second color indicator is enabled.

20. The method of claim 15 wherein the first color indicator is green light and the second color indicator is red light.
